(19) United States
(12) Patent Application Publication
(10) Pub. No.: US 2016/0035021 A1
(43) Pub. Date: Feb. 4, 2016

(54) METHOD AND SYSTEM FOR VERIFYING AN ACCOUNT

(71) Applicant: Cheng-I LIN, New Taipei (TW)

(72) Inventor: Cheng-I LIN, New Taipei (TW)

(21) Appl. No.: 14/605,185

(22) Filed: Jan. 26, 2015

(30) Foreign Application Priority Data
Jul. 30, 2014 (TW) 103126020

(51) Int. Cl. G06Q 40/00

(52) U.S. Cl. CPC G06Q 40/00

(57) ABSTRACT

A method and system for verifying an account used by a user to open or lock a service account through an electronic device is disclosed. The electronic device sends an open or lock request for an identification account and the service account to a cloud server via the Internet. The cloud server comparisons the sent identification account and the service account with the identification account and the service account in a database stored on the cloud server. The cloud server sends the open or lock request to a service provider if the comparison results indicate a matching result. The service provider opens or locks the service account corresponding to the identification account.

### CROSS-REFERENCE TO RELATED APPLICATION

This application claims priority of application No. 103126020, filed on Jul. 30, 2014 in the Taiwan Intellectual Property Office, the entire contents of which are hereby incorporated by reference.

### FIELD OF THE INVENTION

The present invention relates to a method and system for verifying an account, and more particularly to a secure method for sending a request through an electronic device to open or lock a service account.

### BACKGROUND OF THE INVENTION

Secure payment is a topic that is continuously studied and improved in the areas of finance, computers, communications and manufacturing. The conventional single password input has been found to be not secure enough although it has been adopted in financial transactions such as telephone banking and credit card services etc. Credit card fraud, debit card fraud, and passwords being stolen happens from time to time. Additionally, criminal groups can use a falsified credit card, an expired credit card, or a canceled credit card posing as a legitimate credit card for credit card fraud or to steal the customer's credit card information from banks, personal computers, or automated teller machines (ATM's).

Therefore, there is a need to solve the above problems and further improve secure payment.

### SUMMARY OF THE INVENTION

An objective of the present invention is to provide a method and system for verifying an account. A user uses an electronic device to open or lock a service account, thereby protecting personal information, communication, application transactions, authority control, and the electronic device's networking security.

In order to accomplish the above objective and more, the present invention relates to a method for verifying an account used by a user to open or lock a service account through an electronic device, the method comprising the following steps: the user registers an identification account and a service account on a cloud server via the Internet; the cloud server stores the identification account and the service account in a database; the electronic device sends an open or lock request for the identification account and the service account to the cloud server via the Internet; the cloud server compares the identification account and the service account with the identification account and the service account of the database; and the cloud server sends the open or lock request to a service provider via the Internet; so that the service provider opens or locks the service account corresponding to the identification account when the compare result indicates a matching result. Additionally, the present invention comprises a system for verifying an account, the system comprising: an electronic device, connected to the Internet; a cloud server, connected to the Internet, a user registers an identification account and a service account on the cloud server via the Internet, the cloud server comprises a database, the database stores at least one identification account and at least one service account; and a service provider, connects to the cloud server via the Internet; wherein the electronic device sends an open or lock request for the identification account and the service account to the cloud server via the Internet, the cloud server compares the identification account and the service account with the identification account and the service account of the database, and the cloud server sends the open or lock request to a service provider via the Internet; so that the service provider opens or locks the service account corresponding to the identification account when the compare result indicates a matching result.

An advantage of the present invention is that it improves the security performance of the system. Compared to the existing financial payment system, the present invention allows the service account to be set to open from lock state by the electronic device when a user wants to trade (for example: use a credit card account), then a key lock or preset automatic lock is activated within a predetermined time after completion of the transaction. Thus, as long as the service account has not been opened again, credit card fraud is prevented even if the credit card is lost or the password has been stolen.

### BRIEF DESCRIPTION OF THE DRAWINGS

FIG. 1 is a first flowchart showing the method for verifying an account of the present invention;

FIG. 2 is a second flowchart showing the method for verifying an account of the present invention;

FIG. 3 is a schematic view in one embodiment showing the system for verifying an account of the present invention;

FIG. 4 is a first embodiment showing the system for verifying an account of the present invention; and

FIG. 5 is a second embodiment showing the system for verifying an account of the present invention.

### DETAILED DESCRIPTION OF THE INVENTION

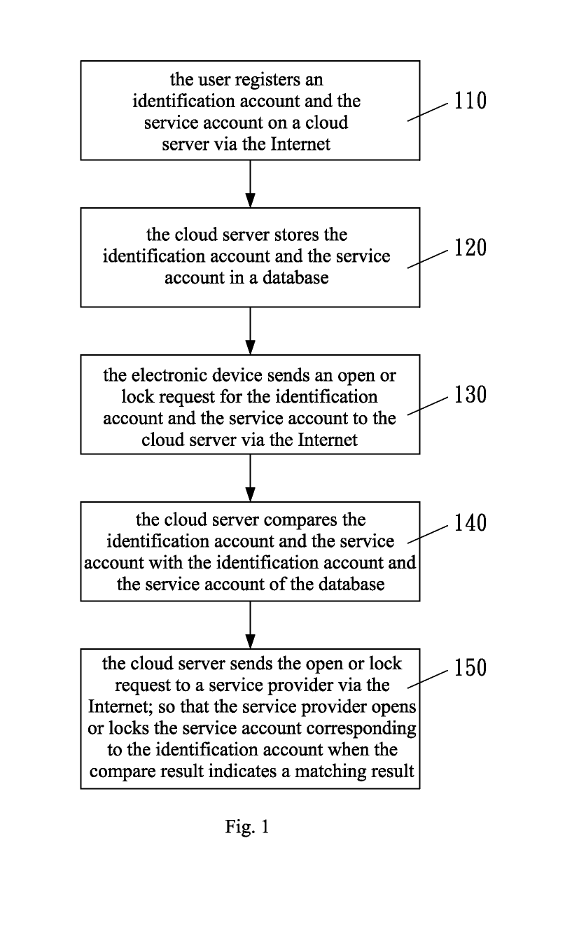

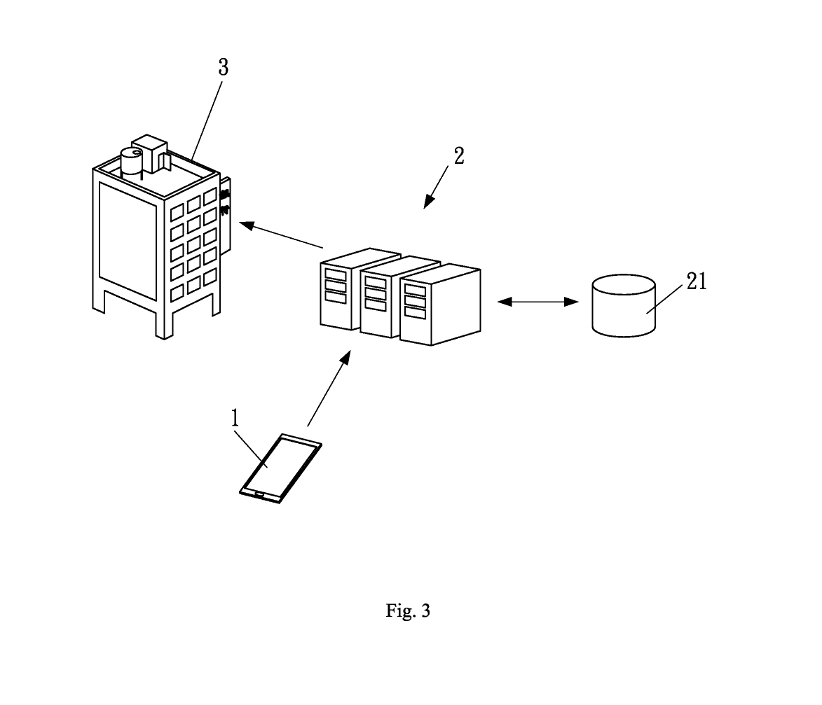

In order to describe details of the preferred embodiment of the present invention, description of the method, system, and the application as well as the steps are made with reference to the accompanying drawings. It is learned that after the description, any variation, modification or the like to the method, system, and the steps of the embodiments of the preferred embodiment of the present invention is easily made available to any person skilled in the art. Thus, the following description is only for illustrative purpose only and does not, in any way, try to limit the scope of the present invention. Refer to FIG. 1 and FIG. 3, which illustrate a method for verifying an account used by a user to open or lock a service account through an electronic device 1. The electronic device 1 comprises mobile devices, tablet PCs, desktop, or notebook computers, but not limited to an electronic devices that have functions connected to the Internet. The method comprises the following steps:

(110) the user registers an identification account and the service account on a cloud server 2 via the Internet. Preferably, the identification account is International Mobile Equipment Identity (IMEI), but not limited to, the identification account can be an account and a password, a single sign on authentication mechanism, etc. The service account can be a credit card account, a game account, or a bank account, etc. The service account can be used for authority control, access control, telecommunications, cloud applications, logistics, home security control, network monitoring locks, and the security of electronic devices that have functions connected to the Internet etc, and it may be multiple, also;

(120) the cloud server 2 stores the identification account and the service account in a database 21;

(130) the electronic device 1 sends an open or lock request for the identification account and the service account to the cloud server 2 via the Internet;

(140) the cloud server 2 compares the identification account and the service account with the identification account and the service account of the database 21; and

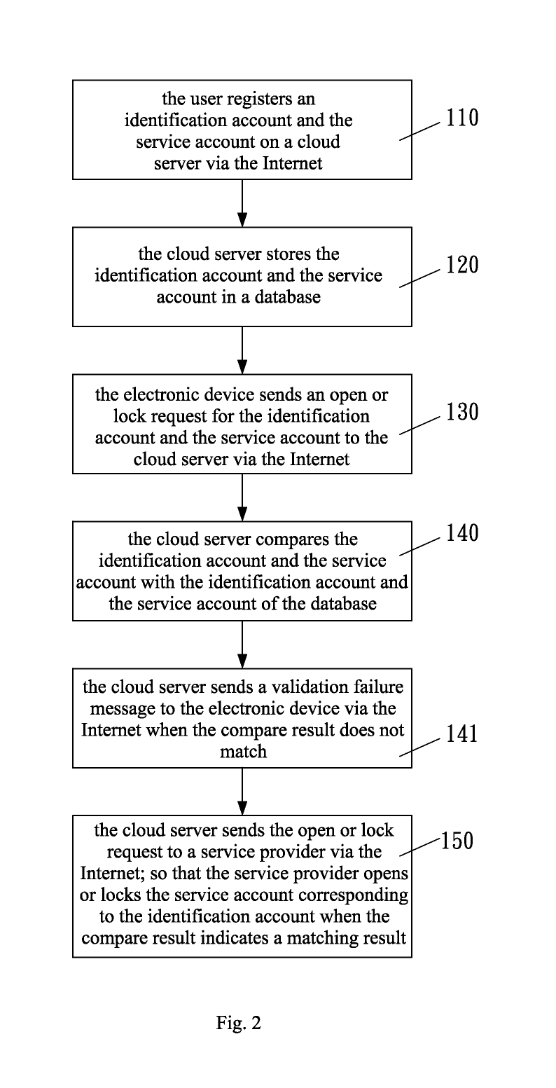

(150) the cloud server 2 sends the open or lock request to a service provider 3 via the Internet; so that the service provider 3 opens or locks the service account corresponding to the identification account when the compare result indicates a matching result. Preferably, the service provider 3 opens or locks the service account corresponding to the identification account within a predetermined amount of time. Refer to FIG. 2 and FIG. 3, wherein a step is included behind the step (140): (141) the cloud server 2 sends a validation failure message to the electronic device 1 via the Internet when the comparison result does not match.

Preferably, the step (120) further comprises: the user connects to the cloud server 2 through an application program of the electronic device 1. The user can download applications which were developed by the service provider 3. For example, bankers develop a customer service application and then the customer uses the application to connect to the cloud server 2.

With further reference to FIG. 3, the present invention also comprises a system for verifying an account, comprising: an electronic device 1 connected to the Internet; a cloud server 2 connected to the Internet, a user registers an identification account and a service account to the cloud server 2 via the Internet, the cloud server 2 comprises a database 21 and the database 21 stores at least one identification account and at least one service account; and a service provider 3 connects to the cloud server 2 via the Internet; wherein the electronic device 1 sends an open or lock request for the identification account and the service account to the cloud server 2 via the Internet, the cloud server 2 compares the sent identification account and the service account with the identification account and the service account of the database 21, the cloud server 2 sends the open or lock request to a service provider 3 via the Internet; so that the service provider 3 opens or locks the service account corresponding to the identification account when the compare result indicates a matching result.

The present invention allows the service account to be set to an open state from a lock state by the electronic device when the user wants to trade (for example: use a credit card account), then return to a key lock or preset automatic lock within a predetermined amount of time after completion of the transaction. Thus, as long as the service account has not been opened again, credit card fraud is prevented even if the credit card was lost or the password had being stolen.

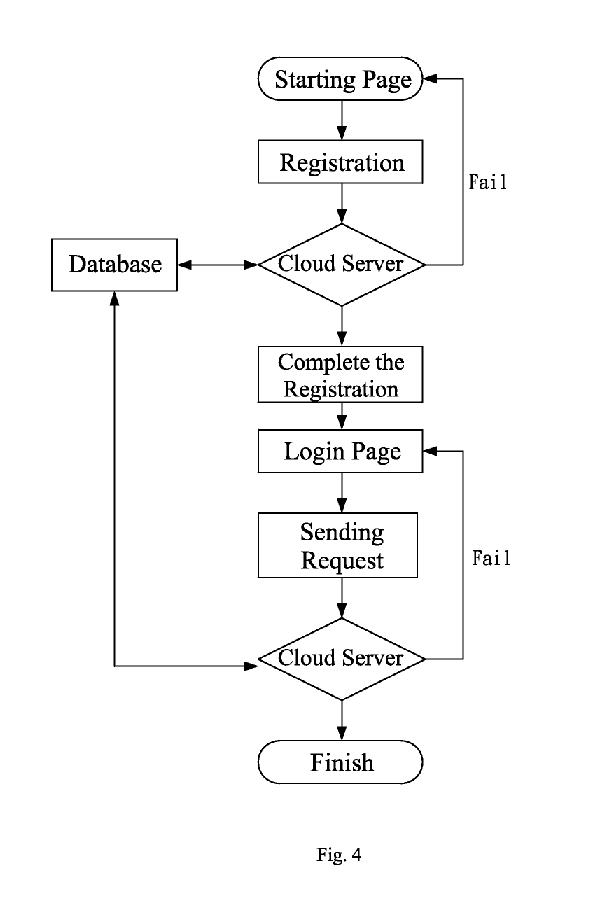

With reference to FIGS. 3 and 4, in an embodiment, a user downloads an application program through a mobile device and registers an identification account and a service account on a cloud server 2 with a starting page via the Internet. The identification account is, for example but not limited to, IMEI. The cloud server 2 stores the identification account and the service account in a database 21. The method returns to the starting page if the user fails to register the identification account or the service account. After the accounts are registered, the user is presented with a login page and logs into the application program. The cloud server 2 compares the identification account with the identification account in the database 21, then the user enters and uses the application program when the compare result indicates a matching result or returns to the login page when the compare result does not match.

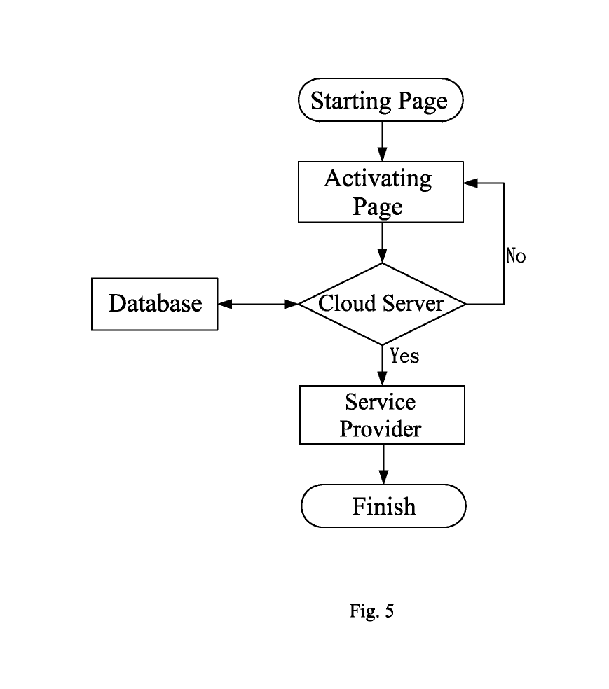

With reference to FIGS. 3 to 5, in another embodiment, the user gets into the activating page after the user logs into the application program. The user can send an open request for the service account to the cloud server 2 with the electronic device 1 via the Internet. For example, the activating page of the application may be provided with an opening switch and the user can press the opening switch to open the service account. The cloud server 2 compares the identification account and the service account with the identification account and the service account in the database 21. The user will return to the activating page if the compare result does not match, or the cloud server 2 sends the open request to a service provider 3 via the Internet, so that the service provider 3 opens the service account corresponding to the identification account when the compare result indicates a matching result. Preferably, the service provider 3 may set up a predetermined amount of time to open the service account. The service account may be restored to the locked state when the user has completed the transaction. The predetermined amount of time may set up by the user or automatically locked within a few minutes.

It is noted that an advantage of the present invention is that it improves the security performance of the system. Compared to the existing financial payment system, the present invention can open or lock a service account through an electronic device 1 and then protect personal information, communication behavior, trading applications, authority control, and the security of electronic devices that have functions connected to the Internet.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for verifying an account used by a user to open or lock a service account through an electronic device, the method comprising the following steps:
registering an identification account and the service account on a cloud server via the Internet, by a user;
storing the identification account and the service account in a database on the cloud server;
sending an open or lock request by the electronic device for the identification account and the service account to the cloud server via the Internet;
comparing sent identification account and sent service account with the identification account and the service account in the database; and
sending the open or lock request to a service provider by the cloud server via the Internet; so that the service provider opens or locks the service account corresponding to the identification account when the comparison result indicates a matching result.

2. The method for verifying an account as claimed in claim 1, wherein the identification account is International Mobile Equipment Identity (IMEI).

3. The method for verifying an account as claimed in claim 1, wherein after the comparing step the method further comprises:
sending a validation failure message from the cloud server to the electronic device via the Internet when the comparison result does not match.

4. The method for verifying an account as claimed in claim 1, wherein the service provider opens or locks the service account corresponding to the identification account within a predetermined amount of time.

5. The method for verifying an account as claimed in claim 1, wherein the user connects to the cloud server through an application program of the electronic device.

6. A system for verifying an account, comprising:
an electronic device connected to the Internet;
a cloud server connected to the Internet allowing a user using the electronic device to register an identification account and a service account with the cloud server via the Internet, the cloud server comprising a database storing at least one identification account and at least one service account; and
a service provider connects to the cloud server via the Internet;
wherein when the electronic device sends an open or lock request for the identification account and the service account to the cloud server via the Internet, the cloud server comparisons the sent identification account and the service account with the identification account and the service account in the database, and the cloud server sends the open or lock request to the service provider via the Internet; so that the service provider opens or locks the service account corresponding to the identification account when the comparison result indicates a matching result.
